(19) United States
(12) Patent Application Publication
(10) Pub. No.: US 2007/0248732 A1
(43) Pub. Date: Oct. 25, 2007

(54) PRESWEETENED BEVERAGE WHITENER

(76) Inventor: Van Miller, Norval (CA)

Correspondence Address: ELIOPOULOS INTELLECTUAL PROPERTY LAW, 2600 SKYMARK AVENUE, SUITE 11-101, MISSISSAUGA, ON, L4W 5B2, CA

(21) Appl. No.: 11/306,067

(22) Filed: Dec. 15, 2005

(51) Int. Cl. A23L 1/236; A23C 13/00; A23C 9/00; A23L 1/00

(52) U.S. Cl. 426/548; 426/580; 426/586; 426/658

(57) ABSTRACT

A presweetened liquid beverage whitener has a predetermined quantity of beverage sweetener dissolved therein, for dispensing into an individual portion of a beverage. The quantity of dissolved sweetener provides a predetermined sweetness coefficient, which is in a range of sweetness determined from 10 g to 30 g of dry granulated sucrose dissolved in 43 ml of cream having 10% to 20% butterfat content. The liquid beverage whitener may be cream having 10% to 20% butterfat content, milk having 1% to 4.5% butterfat content, non-dairy coffee whitener, and mixtures thereof; and the beverage sweetener may be sucrose, glucose, fructose, artificial sweetener, and mixtures thereof. A method is provided which includes the steps of dissolving the sweetener in the whitener, and pasteurizing and packaging the same. Significant savings in time per dispensed cup of whitened and sweetened coffee or other beverage result from the use of the presweetened liquid beverage whitener.

### FIELD OF THE INVENTION

This invention relates to beverage whiteners, and particularly to presweetened beverage whiteners of the sort which are typically used for whitening and sweetening coffee which has been purchased at a coffee concession stand or coffee shop or coffeehouse. In particular, the present invention recognizes that most purchasers of commercially prepared coffee which is dispensed in individual portions request that their coffee be served with whitener and sweetener; and accordingly, the present invention provides for presweetened beverage whiteners which provide a predetermined sweetness coefficient for a given beverage whitening effect.

### BACKGROUND OF THE INVENTION

Throughout North America, in particular, there is a daily ritual among many millions of people. That ritual is stopping at a coffee shop or a coffee concession stand to purchase a cup of coffee. Each cup of coffee which is purchased is ordered and dispensed individually, in keeping with the requirements of the purchaser. Those requirements include the size of the coffee portion being purchased; and more particularly, the amount of coffee whitening to be added to the coffee, and the amount of sweetening to be added to the coffee. Until now, that has meant that the counter person dispensing the coffee must first pour the coffee into a cup, then add whitener—typically cream, but in some cases milk, and rarely (for commercial establishments) artificial whitener—and the counter person must also add sweetener—typically, sugar, but sometimes artificial sweetener. Then, the dispensed coffee and added condiments need to be stirred. However, statistically, most cups of coffee which are dispensed at any commercial establishment, and which have any condiments added to them, are requested to have cream and sugar, or double cream and double sugar. The remaining iterations of condiment additions, namely milk or cream only, or sugar or sweetener only, are requested significantly less often; and any event, they require fewer manual operations, comprising only dispensing the coffee into the cup and then adding a single condiment which has been requested. Even so, the dispensed coffee and single condiment may require to be stirred.

It will be understood from the context of the present discussion that when coffee is discussed, other beverages might also be considered such as tea or hot chocolate, because they may also require additional condiments to be added in the same manner as to coffee. However, the great preponderance of dispensed hot beverages is coffee.

Each cup of coffee which is dispensed requires a significant passage of time for the order to be given by the consumer and noted by the counter person, the fresh coffee to be dispensed by the counter person into a cup, the coffee whitener added, the sweetener added, and then the dispensed beverage and condiments must be stirred. If the last three steps were to be combined into one step, a significant savings of time in dispensing each individual cup of coffee can be attained. Studies have shown that up to six seconds per individual cup of coffee dispensed at a commercial coffee shop or coffee concession stand can be saved by eliminating the steps of adding whitener, adding sweetener, and stirring, and instead by taking the single step of adding a presweetened beverage whitener to the dispensed coffee. Indeed, It is typically unnecessary to stir that coffee/presweetened beverage whitener mixture because the very act of adding the presweetened beverage whitener to the coffee in the cup functions to cause a reasonable stirred mixture.

Accordingly, the present invention seeks to provide a presweetened beverage whitener for use particularly in commercial coffee shops, coffee concession stands, or coffeehouses. The present inventor has quite unexpectedly discovered that a presweetened beverage whitener can, in fact, be prepared and delivered to commercial coffee selling establishments in keeping with specific sweetness coefficients as prescribed by each such commercial coffee selling establishment. Some commercial coffee establishments may establish a reputation for selling coffee which is slightly sweeter or whiter than others, or any event may require a specific sweetness coefficient depending on their own coffee blends and the manner in which they are roasted, etc.

The matter of time which is saved in dispensing each individual cup of coffee is very important from many points of view. First, typically only an individual cup of coffee is dispensed, one at a time, to a single consumer who is purchasing the cup of coffee from the front seat of his automobile and who has been waiting in a lineup of automobiles to obtain the beverage. If the amount of time that each automobile is required to wait while idling its engine is reduced, then the deleterious effect on the environment is reduced. That reason alone can have considerable impact on the economy of the nation in terms of reduced petroleum consumption and gas emissions. In other environments such as coffee concession stands found in mass transit stations of all sorts, and in malls and plazas, the reduction of numbers of customers waiting in line to purchase individually dispensed cups of coffee leads to less crowding, which in turn may lead to less impatience on the part of the customers, and possibly also on the part of the employees of the concession stand.

Typically, a cup of coffee which is dispensed by a commercial coffee establishment is ordered and dispensed with whitener and sweetener, usually cream and sugar. An ordinary or “regular” cup of coffee is considered to have a single condiment serving of coffee whitener and a single condiment serving of sweetener. While the precise amount of coffee whitener and sweetener which constitutes a single condiment serving of either may vary from one commercial establishment to another, typically a single serving of coffee cream may be considered to be about 1 oz.; and typically a single serving of sugar is 2 tsp. or two cubes of sugar. When an order of a cup of coffee is made for a “double double”; that means that the purchaser of the individually dispensed cup of coffee wishes to have double the usual amount of cream and double the usual amount of sugar.

One of the largest commercial coffee chains in Canada and the northern United States has established a standard of condiment servings to be 43 ml of cream and 15 g of dry sugar to establish “double double” condiment servings of each. Typically, the cream is 18% butterfat, but in general, the cream may have a butterfat content of 10% to 20%.

Thus, if a customer orders a “double double” coffee, then the coffee chain will dispense 43 ml of cream and 15 g of dry sugar into the coffee which has already been placed in the cup, followed by stirring. If the customer has ordered a “regular” coffee, then the coffee chain will dispense half of that amount, namely 21.5 ml of cream of cream and 7.5 g of dry sugar. This assumes a standard size (usually, “medium”) cup in which the coffee is dispensed and sold. Since most cups of coffee that are sold are either “regular” or “double double”, it follows that the provision of a presweetened beverage whitener for use by the commercial coffee chain, and its use by the commercial coffee chain, will permit savings of time in serving most customers. If the customer has ordered a non-standard cup of coffee (which might be black, cream only, or sugar only) then the same dispensing station can easily handle that order, while at the same time being prepared to handle the majority of orders which require coffee whitener and sweetener to be dispensed into the coffee.

Once again, the present inventor has quite unexpectedly discovered that a prepared, presweetened beverage whitener can be provided particularly to the commercial coffee industry where cups of coffee are dispensed individually, by dissolving sweetener in beverage whitener; and with additional steps such as pasteurization and packaging, a product having reasonable shelf life can be provided for easy storage and handling by commercial coffee shops and concessions of all sorts.

The present invention recognizes that regional and individual tastes and requirements may easily be met, particularly with respect to the provision of presweetened beverage whiteners. Specifically, it is recognized that typically coffee cream may have about 18% butterfat content, but may be served having butterfat content ranging from 10% up to 20%. Many people prefer milk to cream as their coffee or beverage whitener; and the present invention contemplates a presweetened beverage whitener which is based on milk that typically has from 1% to 4.5% butterfat content. Of course, artificial non-dairy coffee whiteners may also be employed.

The typical coffee sweetener is, of course, sugar. Especially in the case of commercial coffee establishments which dispense individual cups of coffee to the take away trade, the sugar is typically dry granulated sugar. However, in some cases other sweeteners may be employed, including glucose, fructose, and artificial sweeteners.

Nonetheless, a sweetness coefficient may be determined and utilized so as to standardize the formulation for presweetened beverage whiteners which are provided in keeping with the present invention. That sweetness coefficient is typically predicated upon the expectations of the consumer who purchases a “regular” coffee having a single serving of coffee whitener and a single serving of sweetener. For purposes of the present invention, the predetermined sweetness coefficient is determined from the mouth sense and apprehended or detected sweetness of 10 g to 30 g of dry granulated sucrose which has been dissolved in 43 ml of cream having 10% to 20% butterfat content. Once a specific sweetness coefficient has been determined, then the commercial coffee establishment is in the position of being able to dispense 43 ml of the presweetened beverage whitener each time a “double double” cup of coffee has been ordered, and 21.5 ml of the presweetened beverage whitener each time a “regular” cup of coffee has been ordered. As noted, customers of one commercial coffee establishment may expect more or less sweet coffee having a certain whiteness as being the established criterion for that commercial coffee establishment; which may be different from the criteria of sweetness and whiteness of a different commercial coffee establishment. It is interesting to note that since approximately 50% of all cups of coffee that are purchased are requested to be “double double”, it is that condiment additive criterion which is established as a standard for purposes of the present invention.

It now follows that the provision of a presweetened beverage whitener in keeping with the present invention may be attended to by dissolving a predetermined quantity of beverage sweetener into a predetermined quantity of the liquid beverage whitener, and that the resultant product will have the requisite predetermined sweetness coefficient. Moreover, the present invention recognizes that mouth sense and apprehended or detected sweetness of a particular prepared presweetened beverage whitener may be dependent, in part, on the liquid beverage whitener which has been used and also on the type of beverage sweetener that has been used. While the sweetness coefficient is predicated on the use of dry granulated sucrose, it is understood that in some circumstances glucose or fructose might be employed; and that milk or non-dairy coffee whitener may also be employed rather than cream having 10% to 20% butterfat content.

### SUMMARY OF THE INVENTION

In accordance with one aspect of the present invention, there is provided a presweetened liquid beverage whitener having a beverage sweetener dissolved therein, for dispensing into an individual portion of beverage.

The quantity of sweetener which is dissolved in the liquid beverage whitener is predetermined so as to provide a predetermined sweetness coefficient for the consumer of the individual beverage portion.

The liquid beverage whitener is chosen from the group consisting of cream having 10% to 20% butterfat content, milk having 1% to 4.5% butterfat content, non-dairy coffee whitener, and mixtures thereof.

The beverage sweetener is chosen from the group consisting of sucrose, glucose, fructose, artificial sweetener, and mixtures thereof.

The predetermined sweetness coefficient is in a range of sweetness determined from 10 g to 30 g of dry granulated sucrose dissolved in 43 ml of cream having 10% to 20% butterfat content.

Typically, the liquid beverage whitener is cream having 10% to 20% butterfat content, and the beverage sweetener is sucrose in the range of 20% to 30% by weight of dry granulated sucrose dissolved in 70% to 80% by weight of cream.

However, the liquid average whitener may also be milk having 1% to 4.5% butterfat content, while the beverage sweetener is sucrose in the range of 20% to 30% by weight of dry granulated sucrose dissolved in 70% to 80% by weight of milk.

Still further, the liquid beverage whitener may be cream having 10% to 20% butterfat content, with the beverage sweetener being glucose in the range of 20% to 40% by weight of glucose dissolved in 60% to 80% by weight of cream.

Yet again, the liquid beverage whitener may be cream having 10% to 20% butterfat content, with the beverage sweetener being fructose in the range of 25% to 45% by weight of fructose dissolved in 55% to 75% by weight of cream.

As noted, the liquid beverage whitener may also be milk having 1% to 4.5% butterfat content. Thus, in keeping with the above, the presweetened liquid beverage whitener may comprise milk and glucose in the range of 20% to 40% by weight of glucose dissolved in 60% to 80% by weight of cream.

Still further, when the liquid beverage whitener is milk having 1% to 4.5% butterfat content, the beverage sweetener may be fructose in the range of 25% to 45% by weight of fructose dissolved in 55% to 75% by weight of milk.

The present invention also provides a method for manufacturing a presweetened liquid beverage whitener having a beverage sweetener dissolved therein. The presweetened liquid beverage whitener is, of course, in keeping with the description immediately above.

The method comprises the following steps:

(a) Choosing a quantity of liquid beverage whitener and a quantity of beverage sweetener so that, when the beverage sweetener is dissolved in the liquid beverage whitener, the predetermined sweetness coefficient as defined above—sweetness determined from 10 g to 30 g of dry granulated sucrose dissolved in 43 ml of cream having 10% to 20% butterfat content—is achieved.

(b) Dissolving the beverage sweetener in the liquid beverage whitener.

(c) Pasteurizing the resultant solution from step (b).

(d) Packaging the resultant presweetened liquid beverage whitener for storage and handling.

Typically, in carrying out the method of the present invention, step (b) is carried out in the range of 10° C. to 30° C., and step (c) is carried out at temperature of 70° C. to 95° C. for 1 to 30 seconds.

As before, the liquid beverage whitener which is chosen in step (a) may be cream having 10% to 20% butterfat content.

However, is also possible to start step (a) using cream having up to 40% butterfat content, and diluting the cream by a quantity of skim milk so as to reduce the butterfat content of the diluted cream to 10% to 20% butterfat content.

Moreover, the quantities of liquid beverage whitener and beverage sweetener which are chosen in carrying out step (a) may be such as to provide 70% to 80% by weight of cream having 10% to 20% butterfat content, with 20% to 30% by weight of dry granulated sucrose; 70% to 80% by weight of milk having 1% to 4.5% butterfat, with 20% to 30% by weight of dry granulated sucrose; 60% to 80% by weight of cream having 10% to 20% butterfat content, with 20% to 40% by weight of glucose; 60% to 80% by weight of milk having 1% to 4.5% butterfat content, with 20% to 40% by weight of glucose; 55% 75% by weight of cream having 10% to 20% butterfat content, with 25% to 45% by weight of fructose; and 55% to 75% by weight of milk having 1% to 4.5% butterfat, with 25% to 45% by weight of fructose.

### DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

The concept of a predetermined sweetness coefficient has been introduced above. Typically, a predetermined sweetness coefficient is indicative of the mouth sense and apprehended or detected sweetness as it is determined by the consumer. That sweetness, in the case of presweetened beverage whiteners in keeping with the present invention, is predicated on the sweetness which is determined from dissolving 10 g to 30 g of dry granulated sucrose in 43 ml of cream which has 10% to 20% butterfat content. As noted, these criteria are predicated on a sweetness coefficient for a “double double” serving of a cup of coffee.

Based on the predetermined sweetness coefficient, a commercial coffee establishment such as a chain of commercial coffee shops or coffee concession stands may establish its own standard as to what constitutes the requisite amount of coffee whitener and sweetener to establish what may be considered to be its “double double” amount of condiment additive for coffee whitener and coffee sweetener. From that, of course, it follows that what will be the commercial coffee establishment's standard for its “regular” amount of condiment additive for coffee whitener and coffee sweetener is half the amount of its “double double” condiment additive amounts.

It also follows that having established a predetermined sweetness coefficient, it is possible to establish appropriate quantities of beverage sweetener to be dissolved in liquid beverage whitener so as to arrive at a presweetened beverage whitener having that predetermined sweetness coefficient.

It will be noted that any chosen beverage sweetener will dissolve in the chosen liquid beverage whitener at or about room temperature. Thus, it is typically not necessary to heat the liquid beverage whitener before the predetermined quantity of beverage sweetener is dissolved therein. Accordingly, the method of the present invention, whose steps have been described above, is such that step (b) may typically be carried out at a temperature which is in the range of 10° C. up to 30° C. However, it is important that the resultant solution must be pasteurized, and typically that step is carried out at a temperature of 70° C. to 95° C. for a period of from 1 to 30 seconds.

Following the pasteurization step, the presweetened beverage whitener is cooled and packaged, usually in bulk dispensing bags, tubs, or other containers as may be required and employed by the commercial coffee establishment which will be dispensing the presweetened beverage whitener. The packaged presweetened beverage whitener is typically aseptic, at least in the first instance when it is transferred to the commercial coffee establishment where it will be employed in dispensing individual cups of whitened and sweetened beverage.

As previously indicated, studies have shown that utilization of presweetened beverage whiteners in keeping with the present invention can result in a savings of up to six seconds per dispensed cup of whitened and sweetened beverage, compared with the prior practice of having to add beverage whitener and beverage sweetener to the coffee, and then having to stir the same. As noted, this can result in significant savings of time for waiting customers; and when those waiting customers are in their automobiles, significant savings in gasoline consumption and gas emissions will be realized. This, in turn, is beneficial to the environment. Even in the case of customers waiting in line at a coffee concession stand, less crowding and less impatience on the part of individuals concerned may accrue from the utilization of the presweetened beverage whiteners of the present invention.

As stated, most dispensed cups of coffee or other beverage such as tea are dispensed with one or the other of two typical condiment additive standards, either “regular cream or milk and regular sugar or sweetener”, and “double double”, where the quantities of condiment which are dispensed are doubled. That means that most customers of individually dispensed cups of coffee can be served simply by dispensing coffee into a cup and then dispensing a predetermined quantity of the presweetened beverage whitener of the present invention into the cup, with no further steps being required. Of course, it will also be noted that the amount of presweetened beverage whitener to be dispensed into a “small”, “medium”, “large”, or “giant” size cup is easily determined and then controlled, because the flavor and apprehended sweetness of the beverage will remain constant simply by adjusting the amount of presweetened beverage whitener to be dispensed into any particular size of cup.

Typically, the manufacturing steps of the present invention may be carried out in any government approved dairy handling facility. As will be seen by those skilled in the art, there is no necessity for specially designed storage and handling equipment, except that it will be understood that full dissolution of the selected beverage sweetener in the selected beverage whitener must be effected by suitable stirring, swirling, tumbling, or other action. However, those matters are beyond the scope of the present invention, and are well known to those skilled in the art.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A presweetened liquid beverage whitener having a beverage sweetener dissolved therein, for dispensing into an individual portion of a beverage;
wherein the quantity of sweetener dissolved in the liquid beverage whitener is predetermined so as to provide a predetermined sweetness coefficient for the consumer of the individual beverage portion;
wherein the liquid beverage whitener is chosen from the group consisting of cream having 10% to 20% butterfat content, milk having 1% to 4.5% butterfat content, non-dairy coffee whitener, and mixtures thereof;
wherein the beverage sweetener is chosen from the group consisting of sucrose, glucose, fructose, artificial sweetener, and mixtures thereof; and
wherein the predetermined sweetness coefficient is in a range of sweetness determined from 10 g to 30 g of dry granulated sucrose dissolved in 43 ml of cream having 10% to 20% butterfat content.

2. The presweetened liquid beverage whitener of claim 1, wherein the liquid beverage whitener is cream having 10% to 20% butterfat content and the beverage sweetener is sucrose in the range of 20% to 30% by weight of dry granulated sucrose dissolved in 70% to 80% by weight of cream.

3. The presweetened liquid beverage whitener of claim 1, wherein the liquid beverage whitener is milk having 1% to 4.5% butterfat content and the beverage sweetener is sucrose in the range of 20% to 30% by weight of dry granulated sucrose dissolved in 70% to 80% by weight of milk.

4. The presweetened liquid beverage whitener of claim 1, wherein the liquid beverage whitener is cream having 10% to 20% butterfat content and the beverage sweetener is glucose in the range of 20% to 40% by weight of glucose dissolved in 60% to 80% by weight of cream.

5. The presweetened liquid beverage whitener of claim 1, wherein the liquid beverage whitener is cream having 10% to 20% butterfat content and the beverage sweetener is fructose in the range of 25% to 45% by weight of fructose dissolved in 55% to 75% by weight of cream.

6. The presweetened liquid beverage whitener of claim 1, wherein the liquid beverage whitener is milk having 1% to 4.5% butterfat content and the beverage sweetener is glucose in the range of 20% to 40% by weight of dry granulated sucrose dissolved and 60% to 80% by weight of milk.

7. The presweetened liquid beverage whitener of claim 1, wherein the liquid beverage whitener is milk having 1% to 4.5% butterfat content and the beverage sweetener is fructose in the range of 25% to 45% by weight of dry granulated sucrose dissolved and 55% to 75% by weight of milk.

8. A method of manufacture of a presweetened liquid beverage whitener having a beverage sweetener dissolved therein;
wherein the liquid beverage whitener is chosen from the group consisting of cream having 10% to 20% butterfat content, having 1% to 4.5% butterfat content, non-dairy coffee whitener, and mixtures thereof;
wherein the beverage sweetener is chosen from the group consisting of sucrose, glucose, fructose, artificial sweetener, and mixtures thereof; and
wherein said the sweetened beverage whitener has a predetermined sweetness coefficient which is in the range of sweetness determined from 10 g to 30 g of dry granulated sucrose dissolved in 43 ml of cream having 10% to 20% butterfat content;
said method comprising the steps of:
(a) choosing a quantity of liquid beverage whitener and a quantity of beverage sweetener so that, when said beverage sweetener is dissolved in said liquid beverage whitener, said predetermined sweetness coefficient is achieved;
(b) dissolving said beverage sweetener in said liquid beverage whitener;
(c) pasteurizing the resultant solution from step (b); and
(d) packaging the resultant presweetened liquid beverage whitener for subsequent storage and handling.

9. The method of claim 8, wherein step (b) it is carried out at a temperature in the range of 10° C. to 30° C., and step (c) is carried out at a temperature of 70° C. to 95° C. for 1 to 30 seconds.

10. The method of claim 9, wherein the liquid beverage whitener used in step (a) is cream having 10% to 20% butterfat content.

11. The method of claim 9, wherein the liquid beverage whitener used in step (a) is cream having up to 40% butterfat content diluted by a quantity of skim milk so as to reduce the butterfat content of said diluted cream to 10% to 20% butterfat content.

12. The method of claim 9, wherein the quantities chosen in step (a) are 70% to 80% by weight of cream having 10% to 20% butterfat content, and 20% to 30% by weight of dry granulated sucrose.

13. The method of claim 9, wherein the quantities chosen in step (a) are 70% to 80% by weight of milk having 1% to 4.5% butterfat content, and 20% to 30% by weight of dry granulated sucrose.

14. The method of claim 9, wherein the quantities chosen in step (a) are 60% to 80% by weight of cream having 10% to 20% butterfat content, and 20% to 40% by weight of glucose.

15. The method of claim 9, wherein the quantities chosen in step (a) are 60% to 80% by weight of milk having 1% to 4.5% butterfat content, and 20% to 40% by weight of glucose.

16. The method of claim 9, wherein the quantities chosen in step (a) are 55% to 75% by weight of cream having 10% to 20% butterfat content, and 25% to 45% by weight of fructose.

17. The method of claim 9, wherein the quantities chosen in step (a) are 55% to 75% by weight of milk having 1% to 4.5% butterfat content, and 25% to 45% by weight of fructose.
